(19) United States
(12) Patent Application Publication
(10) Pub. No.: US 2016/0074899 A1
(43) Pub. Date: Mar. 17, 2016

(54) VALVE SEAT FOR DISPENSER

(71) Applicant: Illinois Tool Works Inc., Glenview, IL (US)

(72) Inventor: John Ariate Carbajal, Singapore (SG)

(21) Appl. No.: 14/484,771

(22) Filed: Sep. 12, 2014

(51) Int. Cl. B05C 5/02; B05B 1/08; B05C 11/10

(52) U.S. Cl. CPC B05C 5/0225; B05C 11/1034; B05B 1/08

(57) ABSTRACT

A dispensing head includes a housing defining an interior chamber and an inlet formed in the chamber. The inlet supplies the chamber with viscous material under pressure from a source of material. The dispensing head further includes a piston disposed in the chamber and a nozzle secured to the housing at a lower end of the chamber. The nozzle has an orifice extending in a direction co-axial with the chamber, with one of the housing and the nozzle defining a bottom wall of the chamber. The dispensing head further includes a valve seat provided on the bottom wall of the chamber. The valve seat includes a body having a valve seat surface disposed above the bottom wall of the chamber, with the body having an opening co-axial with the orifice of the nozzle to enable viscous material to flow through the valve seat surface during a dispensing operation.

### BACKGROUND OF THE DISCLOSURE

1. Field of the Invention

The invention relates generally to methods and apparatus for dispensing a viscous material on a substrate, such as a printed circuit board, and more particularly to a jetter-type dispenser capable of dispensing small amounts of viscous material on the substrate.

2. Discussion of Related Art

There are several types of prior art dispensing systems or dispensers used for dispensing metered amounts of liquid or paste for a variety of applications. One such application is the assembly of integrated circuit chips and other electronic components onto circuit board substrates. In this application, automated dispensing systems are used for dispensing dots of liquid epoxy or solder paste, or some other related material, onto circuit boards. Automated dispensing systems are also used for dispensing lines of underfill materials and encapsulents, which mechanically secure components to the circuit board. Underfill materials and encapsulents are used to improve the mechanical and environmental characteristics of the assembly.

Another application of such dispensing systems is to dispense very small amounts or dots onto a circuit board. In one system capable of dispensing dots of material, a dispenser unit utilizes a rotating auger having a helical groove to force material out of a nozzle and onto a circuit board. One such system is disclosed in U.S. Pat. No. 5,819,983, entitled LIQUID DISPENSING SYSTEM WITH SEALING AUGERING SCREW AND METHOD FOR DISPENSING, which is owned by Speedline Technologies, Inc. of Franklin, Mass., a subsidiary of the assignee of the present disclosure.

It is also known in the field of automated dispensers to launch dots of viscous material toward the circuit board. Such systems are sometimes referred to as “jetter”-type systems. In such a jetter-type system, a minute, discrete quantity of viscous material is ejected from a nozzle with sufficient inertia to enable the material to separate from the nozzle prior to contacting the circuit board. As discussed above, with the auger-type application or other prior, traditional dispensing systems, it is necessary to wet the circuit board with the dot of material to enable the material to adhere to the circuit board such that when the dispenser is pulled away the dot of material will release from the nozzle. When ejecting, the dots may be deposited on the substrate without wetting as a pattern of discrete dots, or alternatively the dots may be placed sufficiently close to each other to cause them to coalesce into more or less a continuous pattern. An example of such a system is disclosed in U.S. Pat. No. 7,980,197, entitled METHOD AND APPARATUS FOR DISPENSING A VISCOUS MATERIAL ON A SUBSTRATE, which is owned by Illinois Tool Works Inc. of Glenview, Ill., the assignee of the present disclosure.

FIG. 1 illustrates the construction of a well-known jetter-type dispensing head, which is generally indicated at 10. As shown, the dispensing head 10 includes a housing 12 having a chamber 14. Viscous material is introduced into the chamber 14 by a supply inlet 16 provided near the top of the housing 12. A nozzle 18 is provided at the bottom of the chamber 14, with viscous material being dispensed through the nozzle in the traditional manner. The dispensing head 10 further includes a reciprocating piston or valve 20 configured to engage a valve seat 22, which is provided at a bottom of the chamber 14 above the nozzle 18. The arrangement is such that the piston 20, upon engaging the valve seat 22, ejects a quantity of viscous material through the nozzle 18.

FIG. 2 illustrates points of contact of an end of the reciprocating piston 20 on the valve seat 22. One disadvantage associated with jetter-type systems is that it is difficult to control the pressure within the chamber 14 in the space surrounding the valve seat 22. As shown in FIG. 2, the valve seat 22 is formed in a bottom wall 24 of the housing 12. This construction encourages pressure to concentrate in the space around the valve seat 22, and as a result viscous material rushes into an orifice of the valve seat when the piston 20 engages the valve seat. This build up of pressure around the valve seat 22 negatively effects the ability to control the repeatability of the dispensing head 10 when dispensing.

### SUMMARY OF THE DISCLOSURE

One aspect of the disclosure is directed to a dispensing head of a dispenser configured to dispense material on a substrate. In one embodiment, the dispensing head comprises a housing defining an interior chamber and an inlet formed in the chamber. The inlet is configured to supply the chamber with viscous material under pressure from a source of material. The dispensing head further comprises a piston disposed in the chamber and axially movable within the chamber and a nozzle secured to the housing at a lower end of the chamber. The nozzle has an orifice extending in a direction co-axial with the chamber, with one of the housing and the nozzle defining a bottom wall of the chamber. The dispensing head further comprises a valve seat provided on the bottom wall of the chamber. The valve seat includes a body having a valve seat surface disposed above the bottom wall of the chamber, with the body having an opening co-axial with the orifice of the nozzle to enable viscous material to flow through the valve seat surface during a dispensing operation.

Embodiments if the dispensing head further may include shaping the valve seat surface to correspond to a shape of a lower end of the piston. The valve seat surface may be arcuate in shape. The valve seat surface may include a diameter of approximately 1.2 mm The opening of the valve seat may be approximately 0.20 mm in diameter. In one embodiment, the bottom wall may be part of the housing and the valve seat is part of the housing. In another embodiment, the bottom wall is part of the nozzle and the valve seat is part of the nozzle. Viscous material within the chamber may be pressurized at 15 psi or above, and specifically between 15-35 psi. The valve seat surface may be disposed above the bottom wall a distance greater than 1 mm.

### BRIEF DESCRIPTION OF THE DRAWINGS

For a better understanding of the disclosure, reference is made to the figures which are incorporated herein by reference and in which:

FIG. 1 is a schematic cross-sectional view of a jetter-type dispensing head of a prior design;

FIG. 2 is an enlarged cross-sectional view of the dispensing head shown in FIG. 1;

FIG. 3 is a schematic cross-sectional view of a dispensing head having a valve seat of an embodiment of the present disclosure;

FIG. 4 is an enlarged cross-sectional view of the dispensing head shown in FIG. 3;

FIG. 5 is an enlarged cross sectional view of the valve seat;

FIG. 6 is an enlarged top plan view of the valve seat; and

FIG. 7 is a schematic cross-sectional view of a dispensing head having a valve seat of another embodiment of the present disclosure.

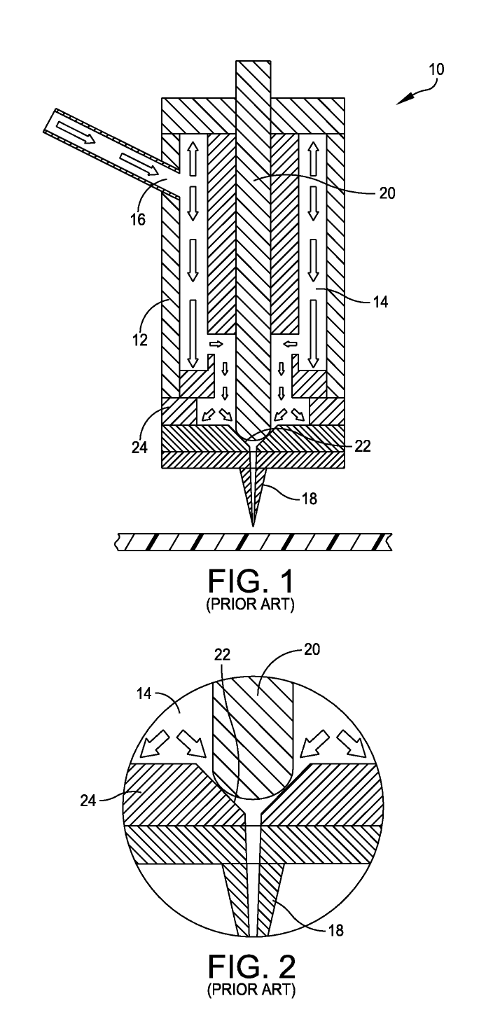

### DETAILED DESCRIPTION OF THE PREFERRED EMBODIMENTS

For the purposes of illustration only, and not to limit the generality, the disclosure will now be described in detail with reference to the accompanying figures. This disclosure is not limited in its application to the details of construction and the arrangement of components set forth in the following description or illustrated in the drawings. The disclosure is capable of other embodiments and of being practiced or being carried out in various ways. Also the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

In a typical application, a dispenser is used to dispense a viscous material (e.g., an adhesive, encapsulent, epoxy, solder paste, underfill material, etc.) or a semi-viscous material (e.g., soldering flux, etc.) onto an electronic substrate, such as a printed circuit board or semiconductor wafer. The dispenser may alternatively be used in other applications, such as for applying automotive gasketing material or in certain medical applications. It should be understood that references to viscous or semi-viscous materials, as used herein, are exemplary and intended to be non-limiting. The dispenser may include one or more dispensing units or heads and a controller to control the operation of the dispenser.

The dispenser may also include a frame having a base or support for supporting the substrate, a dispensing head gantry movably coupled to the frame for supporting and moving the dispensing head, and a weight measurement device or weigh scale for weighing dispensed quantities of the viscous material, for example, as part of a calibration procedure, and providing weight data to the controller. A conveyor system or other transfer mechanism, such as a walking beam, may be used in the dispenser to control loading and unloading of substrates to and from the dispenser. The gantry can be moved using motors under the control of the controller to position the dispensing head at predetermined locations over the substrate. The dispenser may include a display unit connected to the controller for displaying various information to an operator. There may be an optional second controller for controlling the dispensing head.

Prior to performing a dispensing operation, as described above, the substrate, e.g., printed circuit board, must be aligned or otherwise in registration with a dispenser of the dispensing system. The dispenser further includes a vision system, which is coupled to a vision system gantry movably coupled to the frame for supporting and moving the vision system. Although shown separately from the dispensing head gantry, the vision system gantry may utilize the same gantry system as the dispensing head. As described, the vision system is employed to verify the location of landmarks, known as fiducials or other features and components, on the substrate. Once located, the controller can be programmed to manipulate the movement of one or both of the dispensing head to dispense material on the electronic substrate.

Systems and methods of the present disclosure are directed to the construction of the dispensing head. The description systems and methods provided herein reference exemplary electronic substrates (e.g., printed circuit boards), which are supported on the support of the dispenser. In one embodiment, the dispense operation is controlled by the controller, which may include a computer system configured to control material dispensers. In another embodiment, the controller may be manipulated by an operator. Embodiments of the present disclosure are directed to a dispensing head having a valve seat with a contact point elevated from a lowest surface of a chamber of the dispensing head. The elevation of the valve seat with respect to a bottom wall of the chamber enables the dispensing of a low volume of material per piston stroke since a pressure concentration of the viscous material is moved away from a valve seat and a piston. The elevated valve seat within the chamber of the dispensing head improves the capability to dispense high weight viscous material (e.g., material having 1.000 mg or greater), or volume per piston stroke or low weight (e.g., material having 0.010 to 1.000 mg), or ultra low weight (e.g., material below 0.010 mg) or volume per piston stroke. The elevated valve seat within the chamber of the dispensing head also minimizes or eliminates dispensing defects.

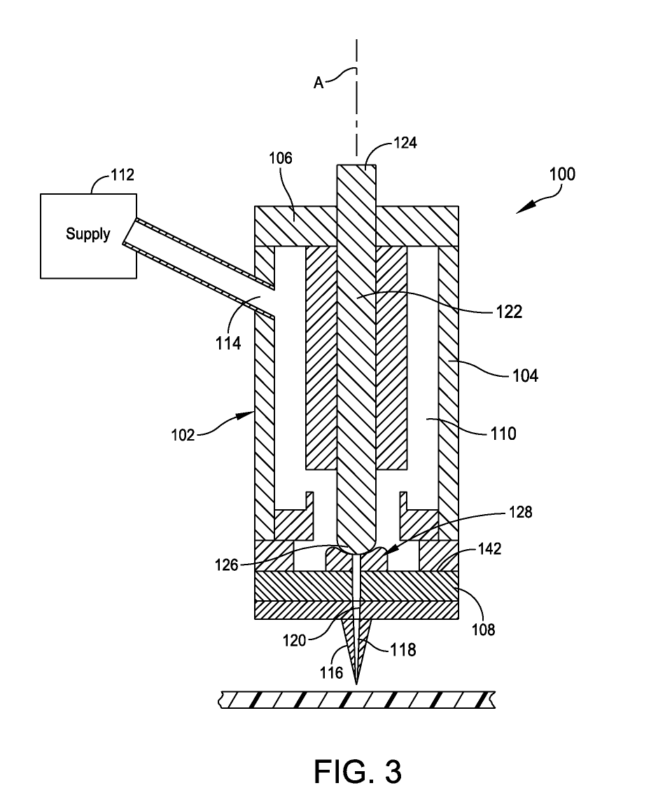

Referring to the drawings, and more particularly to FIG. 3, a dispensing head of one embodiment of the present disclosure is generally indicated at 100. As shown, the dispensing head 100 includes a housing generally indicated at 102, which is designed to contain the working components of the dispensing head. In one embodiment, the housing 102 has a cylindrical wall 104, a top wall 106 defining a top end of the housing and a bottom wall 108 defining a bottom end of the housing. The cylindrical wall 104, the top wall 106 and the bottom wall 108 of the housing 102 together define an interior chamber 110 which is in fluid communication with a viscous material supply 112, which is configured to contain viscous material, such as solder paste. In one embodiment, viscous material is introduced into the chamber 110 by a supply inlet 114 formed in the cylindrical wall 104 of the housing 102 near the top of the cylindrical wall of the housing. The supply inlet 114 is in fluid communication with the supply 112 of viscous material, which can be a supply cartridge of viscous material configured to supply viscous material under pressure to the chamber 110.

In the embodiment shown in FIG. 3, the dispensing head 100 further includes a nozzle 116 mounted on the bottom wall 108 of the housing 102. The nozzle 116 includes an orifice 118 extending along a vertical axis, identified by axis A in FIG. 3, with the orifice being in fluid communication with the chamber 110 of the housing 102 via a co-axial opening 120 formed in the bottom wall 108 of the housing. The arrangement is such that viscous material is dispensed through the orifice 118 of the nozzle 116 to eject viscous material on the substrate during a dispensing operation. The nozzle 116 may be replaced to vary the diameter of the orifice 118 of the nozzle depending on a desired application, which in turn can vary the size of droplets ejected from the nozzle of the dispensing head 100 on the substrate during a dispensing operation.

The dispensing head 100 further includes a reciprocating piston or valve 122 disposed within the chamber 110 of the housing. The piston 122 includes an upper end 124 suitably connected to an actuator configured to drive the up and down movement of the piston within the chamber 110. In one embodiment, the controller controls the operation of the actuator to control the reciprocating movement of the piston 122 within the chamber 110. The piston 122 further includes a lower end 126 configured to mate with a valve seat, generally indicated at 128, which is provided on the bottom wall 108 of the chamber 110 in the shown embodiment. The arrangement is such that the piston 122, upon engaging the valve seat 128, ejects a quantity of viscous material through the orifice 118 of the nozzle 116. As will become apparent as the description of the dispensing head 100 proceeds, the valve seat 128 is designed so that a point of contact between the lower end 126 of the piston 122 and the valve seat is elevated with respect to the bottom wall 108 of the chamber 110. The positioning of the valve seat 128 above the bottom wall 108 of the chamber 110 enhances the ability of the dispensing head 100 to dispense a low volume of material per piston stroke since a pressure concentration of the viscous material is moved away from the valve seat and the piston 122.

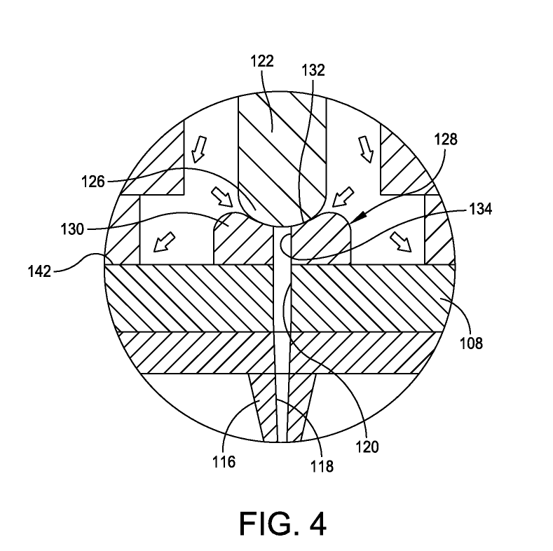

Referring to FIG. 4, the valve seat 128 is shown on the bottom wall 108 of the housing 102 of the dispensing head 100. In one embodiment, the valve seat 128 can be integrally formed with the bottom wall 108 of the housing 102. In this embodiment, the valve seat 128 is machined with the bottom wall 108 of the housing 102 from stock material, e.g., stainless steel. In another embodiment, the valve seat 128 can be secured, e.g., welded, to the bottom wall 108 of the housing 102. In the shown embodiment, the valve seat 128 includes a body 130 having a valve seat surface 132, which is disposed above the bottom wall of the housing and faces the lower end 126 of the piston 122. The valve seat surface 132 is contoured to mate with the lower end 126 of the piston 122.

The body 130 further has an opening 134 that is coaxial with the orifice 118 of the nozzle 116 and the opening 120 of the bottom wall 108 to enable the viscous material to flow through the valve seat surface 132 of the valve seat body 130 during a dispensing operation.

In the shown embodiment, the opening 134 is approximately 0.20 mm in diameter. The size of the opening 120 of the bottom wall 108 of the housing 102 can be selected to match the opening 134 of the valve seat body 130. It should be understood that the diameter of the opening 134 of the valve seat and the opening 120 of the bottom wall 108 of the housing 102 can be selected to cooperate with the diameter of the orifice 118 of the nozzle 116 so that a sufficient amount of viscous material enters the orifice. It should further be understood that a typical nozzle arrangement will provide a nozzle having a smaller orifice than the openings 120, 134 of the bottom wall and the valve seat.

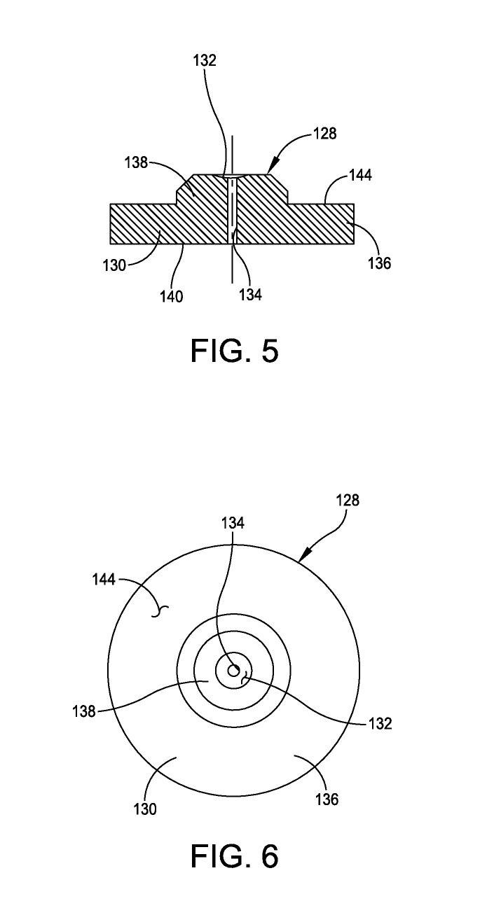

FIGS. 5 and 6 illustrate an exemplary valve seat 128 of embodiments of the present disclosure. As shown, the body 130 of the valve seat 128 includes a base portion 136 configured to rest on the bottom wall 108 of the housing 102 and a valve seat portion 138 on which the valve seat surface 132 is machined. The base portion 136 of the valve seat body 130 includes a bottom surface 140 that is secured to the bottom wall 108 of the housing 102 of the dispensing head 100. As discussed above, the base portion 136 of the valve seat body 130 may be suitably secured by any known method to the bottom wall 108 of the housing 102. The valve seat body 138 may be fabricated from a suitable material capable of being subjected to repeated engagement by the piston 122 during operation. In one embodiment, the valve seat body 130 may be fabricated from stainless steel.

As best shown in FIG. 4, the valve seat surface 132 is shaped to correspond to a shape of the lower end 126 of the piston 122. In the shown embodiment, the lower end 126 of the piston 122 is arcuate in shape, thereby making the valve seat surface 132 arcuate in shape as well. In one exemplary embodiment, the valve seat surface 132 has a diameter of approximately 1.2 mm The valve seat body 130 is shaped so that the valve seat surface 132 is disposed above a top surface 142 of the bottom wall 108 a distance greater than 1 mm. In the shown embodiment, the valve seat surface 132 is disposed above the top surface 142 of the bottom wall 108 a distance of 1.44 mm and 0.64 mm above a top surface 144 of the base portion 136 of the valve seat body 130. The valve seat portion 138 includes chamfered edges to isolate the valve seat surface 132. The foregoing dimensions for the valve seat 128 are exemplary only and may be varied depending on the particular application.

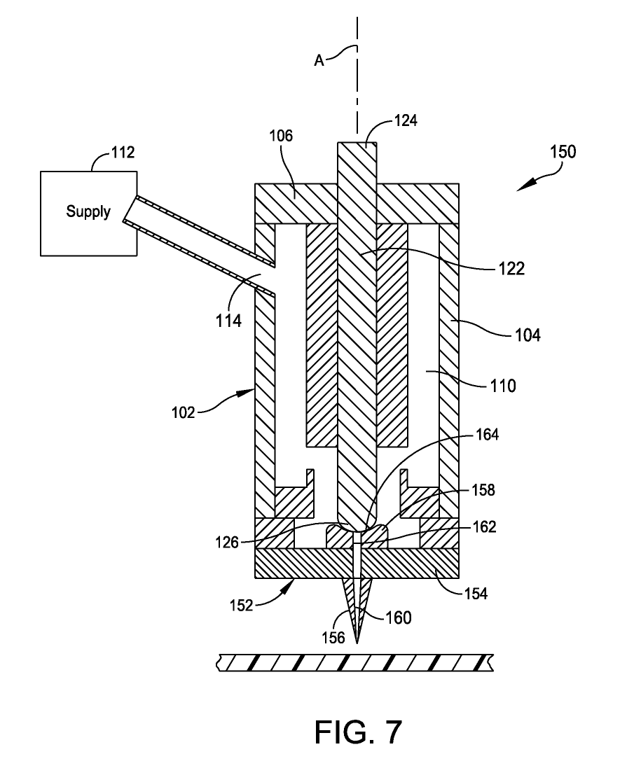

Referring to FIG. 7, a dispensing head of another embodiment of the present disclosure is generally indicated at 150. The components of the dispensing head 150 are substantially similar to dispensing head 100 except for the construction of the bottom wall and the nozzle of the dispensing head 150. In the embodiment shown in FIG. 7, the housing 102 of the dispensing head 150 includes a bottom wall generally indicated at 152 that is integrally formed to include a bottom wall portion 154, a nozzle portion 156 and a valve seat portion 158. As shown, the nozzle portion 156 includes an orifice 160 in fluid communication with the chamber 110 of the housing 102 via a co-axial opening 162 formed in the bottom wall portion 154 and the valve seat portion 158. In one embodiment, the opening 162 formed in the bottom wall portion 154 and the valve seat portion 158 has a diameter (e.g., approximately 0.20 mm) that is greater than a diameter of the orifice 160 of the nozzle portion 156. The orifice 160 of the nozzle portion 156 can be selected to a desired amount of material to be deposited on the substrate during a dispensing operation.

As with dispensing head 100, the lower end 126 of the piston 122 of the dispensing head 150 is configured to mate with a valve seat surface 164 of the valve seat portion 158. As shown, the valve seat surface 164 is elevated with respect to the bottom wall portion 154 so that the point of contact between the lower end 126 of the piston 122 and the valve seat surface is elevated with respect to the bottom wall portion of the chamber 110. In the shown embodiment, the bottom wall portion 154, the nozzle portion 156 and the valve seat portion 158 are integrally formed as one piece. In this embodiment, the bottom wall 152 is machined to create the bottom wall portion 154, the nozzle portion 156 and the valve seat portion 158 from stock material, e.g., stainless steel.

It should be observed that the valve seat design of embodiments of the present disclosure enable operation of the dispensing head at greater pressures. Depending on the viscosity of the material being dispensed, a typical dispensing head operates at a relatively low pressure, e.g., 1-10 psi. However, with the valve seat design of the present disclosure, the dispensing heads are configured to pressurize the viscous material within the chamber at 15 psi or above, depending on the viscosity of the material. More particularly, the dispensing heads can operate at chamber pressures of 15-35 psi, again depending on the viscosity of the material being dispensed.

Having thus described at least one embodiment of the disclosure, various alternations, modifications and improvements will readily occur to those skilled in the art. Such alterations, modifications and improvements are intended to be within the scope and spirit of the disclosure. Accordingly, the foregoing description is by way of example only and is not intended to be limiting. The limit is defined only in the following claims and equivalents thereto.

What is claimed is:

1. A dispensing head of a dispenser configured to dispense material on a substrate, the dispensing head comprising:
a housing defining an interior chamber;
an inlet formed in the chamber, the inlet being configured to supply the chamber with viscous material under pressure from a source of material;
a piston disposed in the chamber and axially movable within the chamber;
a nozzle secured to the housing at a lower end of the chamber, the nozzle having an orifice extending in a direction co-axial with the chamber, one of the housing and the nozzle defining a bottom wall of the chamber; and
a valve seat provided on the bottom wall of the chamber, the valve seat including a body having a valve seat surface disposed above the bottom wall of the chamber, the body having an opening co-axial with the orifice of the nozzle to enable viscous material to flow through the valve seat surface during a dispensing operation.

2. The dispensing head of claim 1, wherein the valve seat surface is shaped to correspond to a shape of a lower end of the piston.

3. The dispensing head of claim 1, wherein the valve seat surface is arcuate in shape.

4. The dispensing head of claim 3, wherein the valve seat surface includes a diameter of approximately 1.2 mm.

5. The dispensing head of claim 4, wherein the opening of the valve seat is approximately 0.20 mm in diameter.

6. The dispensing head of claim 1, wherein the bottom wall is part of the housing.

7. The dispensing head of claim 6, wherein the valve seat is part of the housing.

8. The dispensing head of claim 1, wherein the bottom wall is part of the nozzle.

9. The dispensing head of claim 8, wherein the valve seat is part of the nozzle.

10. The dispensing head of claim 1, wherein viscous material within the chamber is pressurized at 15 psi or above.

11. The dispensing head of claim 1, wherein viscous material within the chamber is pressurized at 15-35 psi.

12. The dispensing head of claim 1, wherein the valve seat surface is disposed above the bottom wall a distance greater than 1 mm.
